(19) United States
(12) Patent Application Publication
(10) Pub. No.: US 2013/0091502 A1
(43) Pub. Date: Apr. 11, 2013

(54) SYSTEM AND METHOD OF PROVIDING VIRTUAL MACHINE USING DEVICE CLOUD

(71) Applicants: Dong-Oh KANG, Daejeon-si (KR); Chang-Seok BAE, Daejeon-si (KR); Jeun-Woo LEE, Daejeon-si (KR)

(72) Inventors: Dong-Oh KANG, Daejeon-si (KR); Chang-Seok BAE, Daejeon-si (KR); Jeun-Woo LEE, Daejeon-si (KR)

(73) Assignee: Electronics and Telecommunications Research Institute, Daejeon-si (KR)

(21) Appl. No.: 13/614,039

(22) Filed: Sep. 13, 2012

(30) Foreign Application Priority Data
Oct. 11, 2011 (KR) 10-2011-0103730

(51) Int. Cl. G06F 9/455

(52) U.S. Cl. 718/1

(57) ABSTRACT

A system of providing a virtual machine using a device cloud is provided. The system includes a terminal that includes a user interface for a virtual machine request in a server providing cloud services, at least one component device that is registered in the server to be usable as a virtual machine, and a server that registers the at least one component device as a resource usable as the virtual machine, and controls the at least one component device to operate as the virtual machine usable by the terminal in response to a request from the terminal.

### CROSS-REFERENCE TO RELATED APPLICATION

This application claims the benefit under 35 U.S.C. §119(a) of Korean Patent Application No. 10-2011-0103730, filed on Oct. 11, 2011, the entire disclosure of which is incorporated herein by reference for all purposes.

### BACKGROUND

1. Field

The following description relates to a cloud computing technique, and more particularly, to an apparatus and method of providing a virtual machine using a device cloud.

2. Description of the Related Art

Cloud computing allows users to easily lend storage, network, platform, and computer resources using distributed processing technology and virtualization technology. For example, for services utilizing a large amount of mobile resources, an infrastructure having a significant scale is required. Here, the infrastructure is easily implemented in conjunction with cloud computing constructed in advance, and users pay operation costs only for the amount that they use, thereby reducing unnecessary waste of surplus resources.

In the existing cloud computing field, a virtual desktop technique utilizing a virtual machine for general users provides service on a hosted virtual desktop according to a VDI (virtual desktop infrastructure) scheme. In this case, a virtual machine of a user operates in a central server and a terminal connects to and uses the virtual machine using remote desktop software.

However, this approach is vulnerable to network influences, and performance of the user connecting to the virtual machine deteriorates when the network condition gets bad. In addition, this approach is a centralized method and only one-to-one connection between terminals and servers is maintained. Accordingly, a method of utilizing scattered devices is inconvenient and there are cases in which the devices cannot be utilized.

### SUMMARY

The following description relates to a system and method of providing a virtual machine using a device cloud, in which a server program operates in scattered devices so that the devices compose a cloud, and a user can do computing using only a terminal that can use a device cloud without possessing a computer.

In one general aspect, there is provided a system of providing a virtual machine using a device cloud, the system including: a terminal that includes a user interface for a virtual machine request in a server providing cloud services; at least one component device that is registered in is the server to be usable as a virtual machine; and a server that registers the at least one component device as a resource usable as the virtual machine, and controls the at least one component device to operate as the virtual machine usable by the terminal in response to a request from the terminal.

In another general aspect, there is provided a method of providing a virtual machine to at least one terminal in a server device providing cloud services, the method including: receiving a virtual machine request from the terminal; composing the virtual machine in accordance with the virtual machine request from the terminal; and controlling the composed virtual machine to operate.

Other features and aspects will be apparent from the following detailed description, the drawings, and the claims.

### BRIEF DESCRIPTION OF THE DRAWINGS

FIG. 1 is a schematic configuration diagram illustrating a system of providing a virtual machine using a device cloud according to a preferred embodiment of the present invention;

FIG. 2 is a diagram illustrating a detailed inner configuration of a system of providing a virtual machine using a device cloud according to a preferred embodiment of the present invention;

FIG. 3 is a diagram illustrating a detailed inner configuration of a device cloud proxy bridge according to a preferred embodiment of the present invention; and

FIGS. 4A to 4C are signal flowcharts illustrating a method of providing a virtual machine using a device cloud according to a preferred embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

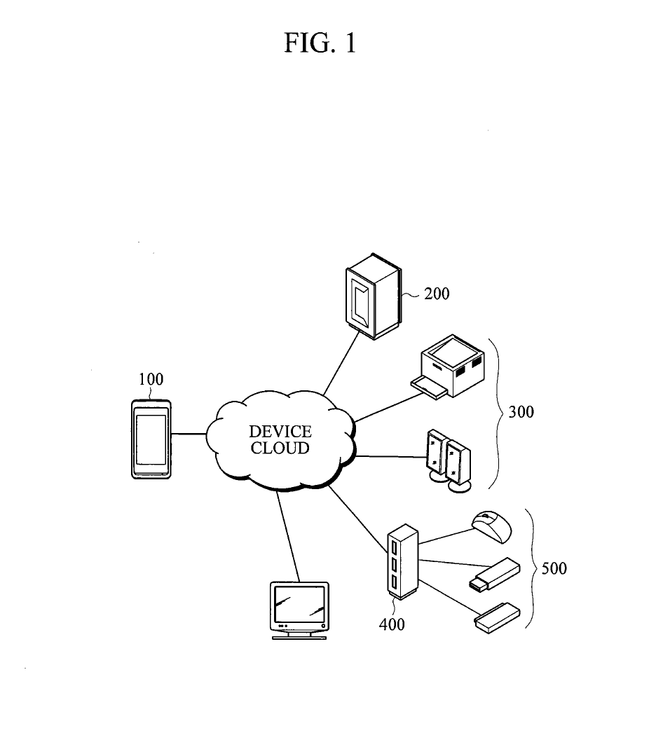

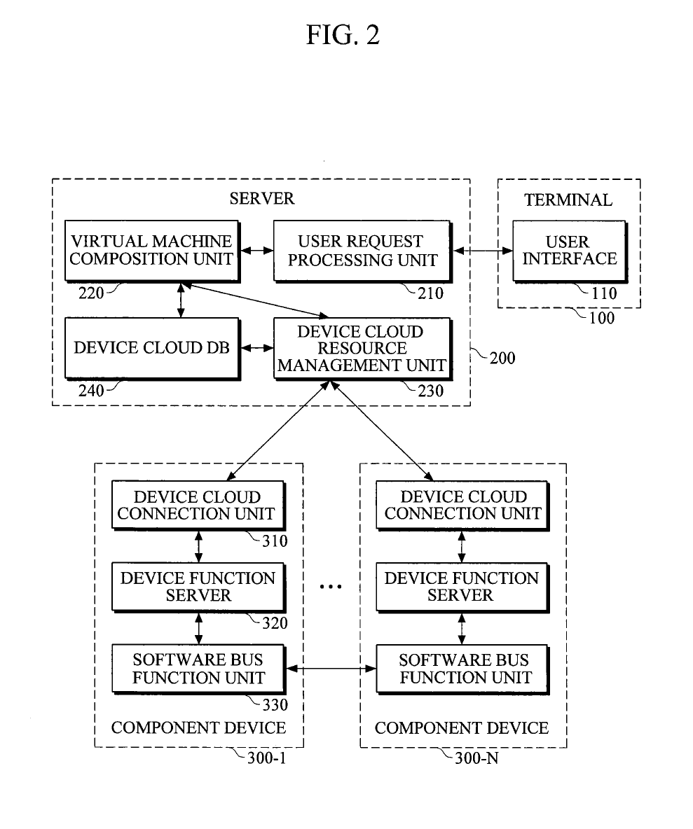

FIG. 1 is a schematic configuration diagram illustrating a system of providing a virtual machine using a device cloud according to an embodiment of the present invention, and FIG. 2 is a diagram illustrating a detailed inner configuration of a system of providing a virtual machine using a device cloud according to an embodiment of the present invention. Hereinafter, preferred embodiments of the present invention will be described in detail with reference to FIGS. 1 and 2.

A system of providing a virtual machine using a device cloud according to a preferred embodiment of the present invention includes a terminal 100, a server 200, and at least one component device 300.

The terminal 100 is a terminal only having a simple user interface 110, or a terminal having built-in software for a user interface.

The user interface 110 transmits a user's request to the server 200 providing device cloud services while communicating with the server 200.

The server 200 registers the at least one component device 300 as a resource usable as a virtual machine and controls the at least one component device 300 to operate as the virtual machine usable by the terminal 100 in response to a request from the terminal 100.

Specifically, the server 200 includes a user request processing unit 210, a virtual machine composition unit 220, a device cloud resource management unit 230, and a device cloud DB 240.

The user request processing unit 210 is a communication interface which receives a user's request from the terminal 100 and transmits the received user's request to the virtual machine composition unit 220, or transmits a composition result processed by the virtual machine composition unit 220 to the terminal 100.

The virtual machine composition unit 220 detects information about resources within the device cloud that have already been registered from the device cloud DB 240 when a virtual machine providing request is input from a user, and transmits the detected information to the user through the user request processing unit 210. Next, the user selects the component devices to be used as the virtual machine through the user interface 110, and the virtual machine composition unit 220 receiving selection information allows the selected component devices to compose the virtual machine through a control command of the device cloud resource management unit 240.

The device cloud resource management unit 240 receives resource information about the component devices connected to the device cloud and stores the received resource information in the device cloud DB 230 as a device to compose the virtual machine. In addition, when a request to compose and operate the virtual machine is received from the virtual machine composition unit 220, the device cloud resource management unit 240 controls a software bus connection to the component devices for composing the virtual machine.

The device cloud DB 240 stores resource information of the component devices 300-1, . . . , 300-N input from the device cloud resource management unit 230, and also stores information of the component device composed as the virtual machine.

The device cloud DB 240 provides information about the devices in response to the request of the virtual machine composition unit 220.

The server 200 may be implemented as a single machine or in a server system in which functions are distributed.

The component devices 300-1, . . . , and 300-N may be registered in the server 300 to be used as the virtual machine, and specifically, are composed of a device cloud connection unit 310, a device function server 320, and a software bus function unit 330.

The device cloud connection unit 310 is responsible for the connection with the server 200 so that the component device 300-1 is included in the device cloud.

The device function server 320 performs and provides a unique function of each of the component devices. The software bus function unit 330 performs connection between the component devices 300-1, . . . , and 300-N such that unique functions of the component devices are linked to compose the virtual machine.

Each of the component devices 300-1, . . . , and 300-N may be implemented in a single device in a physical manner, or several of the component devices 300-1, . . . , and 300-N may be implemented in a single physical device.

In addition, referring to FIG. 1, according to the preferred embodiment of the present invention, the system of providing the virtual machine may further include a proxy bridge 400 that connects the legacy device 500. The existing legacy device 500 does not have a device cloud connection function, and therefore, the proxy bridge 400 is required to enable the existing legacy device 500 to be utilized in the device cloud.

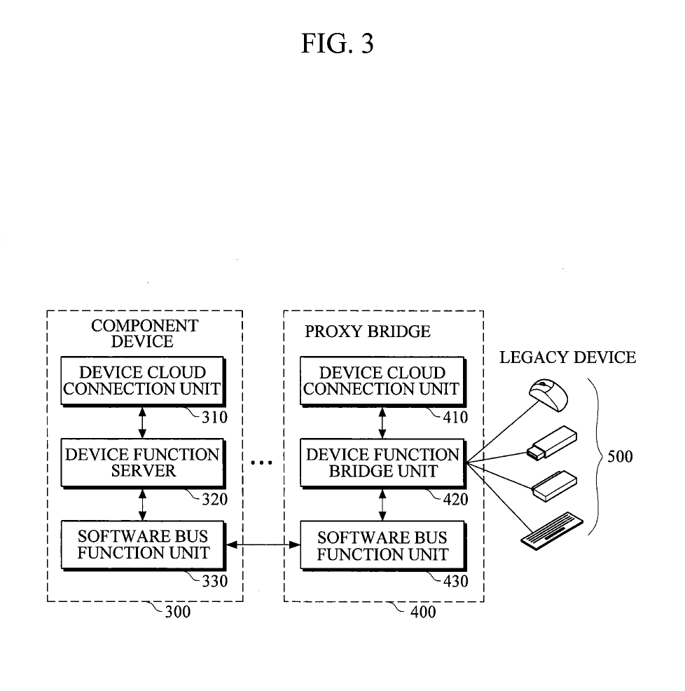

FIG. 3 is a diagram illustrating a detailed inner configuration of a device cloud proxy bridge according to a preferred embodiment of the present invention.

Referring to FIG. 3, the proxy bridge 400 uses a device function bridge unit 420 as a component instead of using the device function server, which is different from the component devices 300, to thereby control the legacy device 500 to operate.

The device function bridge unit 400 ascertains a function of the legacy device 500, and enables the legacy device 500 to be recognized by the device cloud through the device cloud connection unit 410.

The device cloud connection unit 410 is responsible for connection with the server 200 so that the legacy device 500 is included in the device cloud.

The software bus function unit 430 performs connection between other legacy devices or the component devices 300-1, . . . , and 300-N such that unique functions of the legacy devices 500 are linked to compose the virtual machine.

An interlocking operation between components of the system of providing the virtual machine using the device cloud described above will be described in detail together with a method of providing a virtual machine using a device cloud.

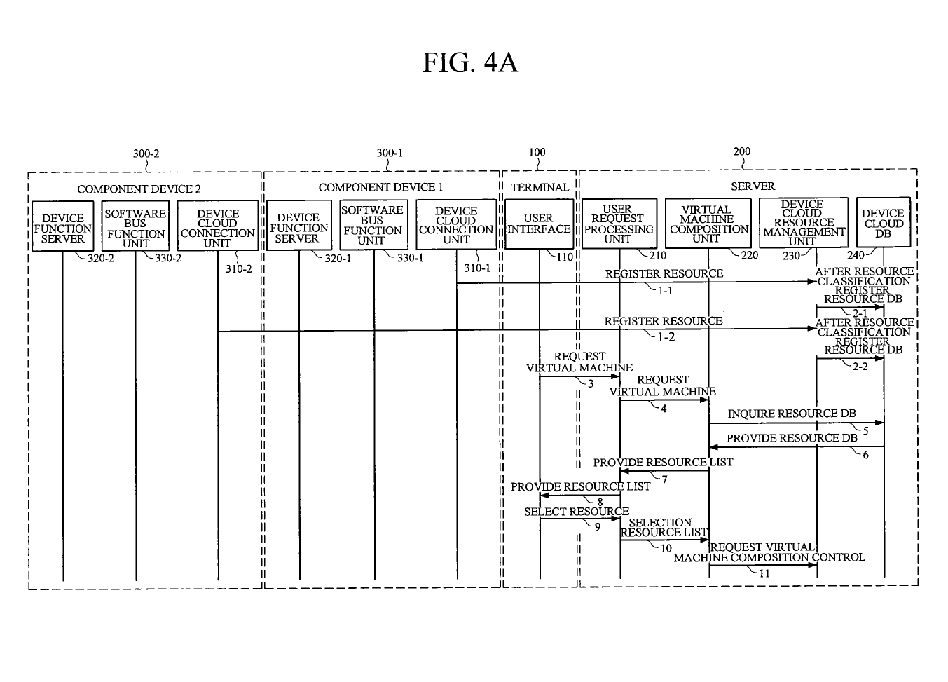

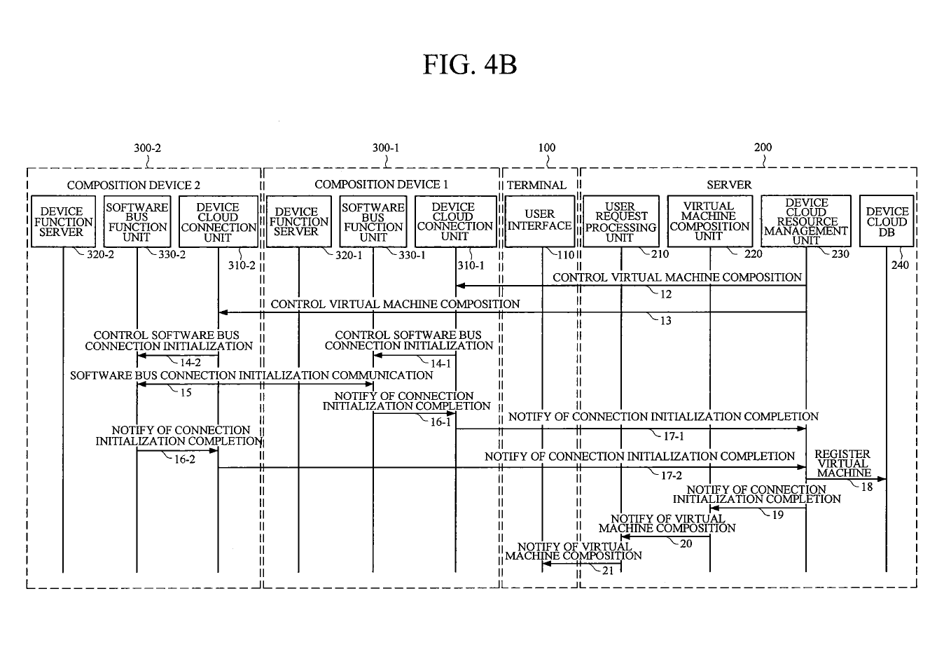

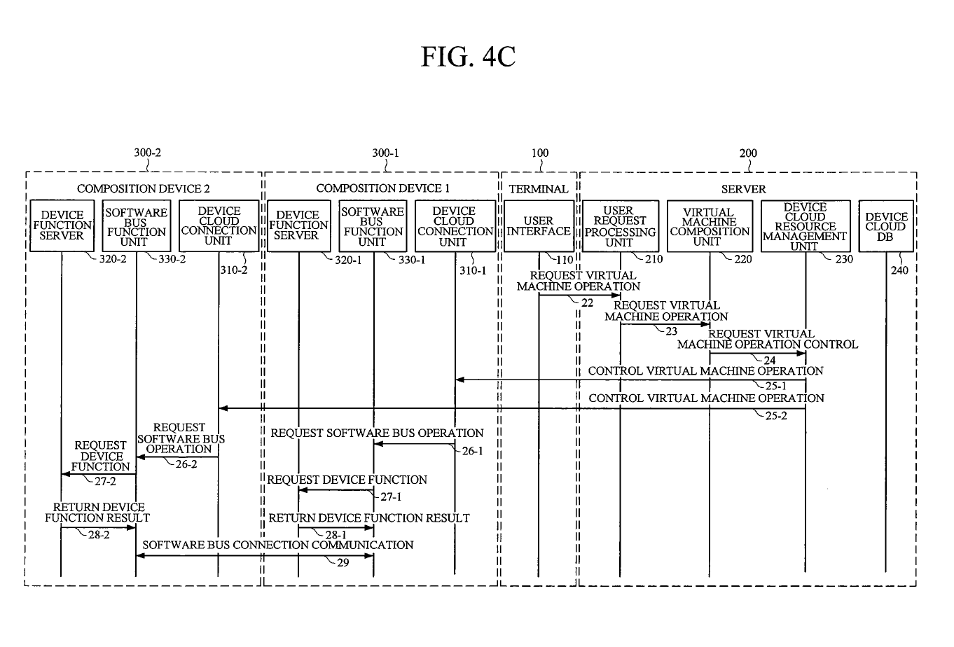

FIGS. 4A to 4C are signal flowcharts illustrating a method of providing a virtual machine using a device cloud according to a preferred embodiment of the present invention.

The method of providing the virtual machine using the device cloud according to the preferred embodiment of the present invention includes receiving a virtual machine request from a terminal (see, FIG. 4A), composing the virtual machine in accordance with the virtual machine request from the terminal (see, FIG. 4B), and controlling the composed virtual machine to operate (see, FIG. 4C).

Next, a detailed configuration of each operation will be described with reference to FIGS. 4A to 4C.

FIG. 4A is a signal flowchart illustrating a process of receiving the virtual machine request.

Before the virtual machine is requested by the terminal, resources must be registered in the server 200 by the component devices 300-1 and 300-2.

Referring to FIG. 4A, in operations 1-1 and 1-2, the device cloud connection units 310-1 and 310-2 of the component devices 300-1 and 300-2 transmit resource registration information to the server 200.

Specifically, the device cloud connection units 310-1 and 310-2 transmit the resource registration information to the device cloud resource management unit 230.

Next, the device cloud resource management unit 230 receiving the resource registration classifies the component devices based on the received resource registration information, and then registers information of the component devices as a resource DB in the device cloud DB 240.

Next, in operation 3, a virtual machine request signal is input from the terminal 100, and in operation 4, the virtual machine request signal is transmitted from the user request processing unit 210 to the virtual machine composition unit 220.

Next, in operation 5, the virtual machine composition unit 220 makes a query into the resource DB of the device cloud DB 240.

Next, in operation 6, the resource DB is provided from the device cloud DB 240.

Next, in operations 7 and 8, the virtual machine composition unit 220 generates a resource list using the received resource DB and transmits the generated resource list to the terminal 100 through the user request processing unit 210.

Next, in operation 9, the terminal 100 selects resources with reference to the received resource list and transmits the selected resource information to the server 200.

In operation 10, the user request processing unit 210 transmits the selection resource list received by the virtual machine composition unit 220 in operation 11, the virtual machine composition unit 220 transmits a virtual machine composition control request to the device cloud resource management unit 230.

FIG. 4B is a signal flowchart illustrating a process of composing the virtual machine in response to the virtual machine request from the terminal.

Referring to FIG. 4B, in operations 12 and 13, the device cloud resource management unit 230 transmits a virtual machine composition control signal to each of the component devices included in the selection resource list. That is, the virtual machine composition control signal is transmitted to the component devices included in the selection resource list. Here, an example in which the component devices 1 and 2 (300-1 and 300-2) are included in the selection resource list is illustrated for convenience, however at least three component devices may be provided.

Next, in operations 14-1 and 14-2, each of device cloud connection units 310-1 and 310-2 of the component devices 1 and 2 (300-1 and 300-2) transmits a software bus connection initialization control signal to the software bus function units 330-1 and 330-2.

Next, in operation 15, the component devices 1 and 2 (300-1 and 300-2) communicates with each other to thereby perform a software bus connection initialization communication.

In operations 16-1 and 16-2, when the software bus connection communication is completed, the software bus function units 330-1 and 330-2 transmit a connection initialization completion notification signal to each of the device cloud connection units 310-1 and 310-2.

Next, in operations 17-1 and 17-2, the device cloud connection units 310-1 and 310-2 transmit the connection initialization completion notification signal to the device cloud resource management unit 230.

Next, in operation 18, the device cloud resource management unit 230 registers corresponding component devices as the virtual machine in accordance with connection initialization information, and in operation 19, the device cloud resource management unit 230 transmits the connection initialization completion notification signal.

Next, in operation 20, the virtual machine composition unit 230 transmits a virtual machine composition notification to the user request processing unit 210.

Next, in operation 21, the user request processing unit 210 transmits the virtual machine composition notification to the terminal 100 and completes a process of registering the virtual machine.

FIG. 4C is a signal flowchart illustrating a process of controlling the composed virtual machine to operate.

Referring to FIG. 4C, in operation 22, the terminal 100 requests a virtual machine operation from the server 200.

Next, in operation 23, the user request processing unit 210 transmits the virtual machine operation request to the device cloud resource management unit 230 through the virtual machine composition unit 220.

Next, in operations 25-1 and 25-2, the device cloud resource management unit 230 transmits a virtual machine operation control signal to the component devices 300-1 and 300-2.

Next, in operations 26-1 and 26-2, the device cloud connection units 310-1 and 310-2 transmit a software bus operation request to the software bus function units 330-1 and 330-2.

Next, operations 27-1 and 27-2, each of the software bus function units 330-1 and 330-2 transmits a device function request to the device function servers 320-1 and 320-2 and the device function servers 320-1 and 320-2 return a device function result.

Next, in operation 29, the software bus function units 330-1 and 330-2 perform software bus connection communication with each other.

Next, the terminal 100 may use the component devices 300-1 and 300-2 as the virtual machine to thereby receive cloud services.

As described above, according to the embodiments of the present invention, a user may compose his own virtual machine using resources allocated from the device cloud using only a simple terminal capable of connecting to the device cloud to thereby compose a computing environment, and may enhance a utilization rate by easily utilizing scattered devices.

In addition, it is possible to compose a more scalable computing environment using characteristics of each device compared to a case of using a single computer.

In addition, in the cloud services using the present invention, a user can easily use his/her own computing environment even when on the move without specific devices, thus enabling smart work such as mobile work, telecommuting, and the like.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A server device, comprising:
a user request processing unit that is a communication interface managing transmission/reception of information with a terminal;
a device cloud database in which at least one component device is registered as a resource usable as a virtual machine;
a virtual machine composition unit that controls the at least one component device registered in the device cloud database to operate as the virtual machine when the virtual machine is requested by a user through the user request processing unit; and
a device cloud resource management unit that controls software bus connection for virtual machine composition of the requested component devices when a virtual machine composition control request is input from the virtual machine composition unit.

2. The server device according to claim 1, wherein the device cloud resource management unit receives information of the component devices and stores the received information in the device cloud database as a device to compose the virtual machine.

3. The server device according to claim 1, wherein the virtual machine composition unit detects a resource list for the at least one component device registered in the device cloud database to thereby provide the detected resource list to the terminal when the virtual machine is requested by the user, and requests that the device cloud resource management unit compose the virtual machine from the component devices included in the resource list selected by the terminal.

4. The server device according to claim 1, wherein the device cloud resource management unit transmits a virtual machine composition control signal to the component devices of the virtual machine whose composition is requested, and registers the corresponding component devices in the virtual machine in response to a connection initialization-completion notification from the component devices.

5. The server device according to claim 4, wherein the device cloud resource management unit transmits a virtual machine composition notification to the terminal in response to the connection initialization completion notification from the component device.

6. The server device according to claim 4, wherein the device cloud resource management unit transmits a virtual machine operation control signal to the component devices when a virtual machine operation is requested by the terminal.

7. A component device, comprising:
a device cloud connection unit that performs connection with a server;
a device function server that performs a virtual machine function when a virtual machine operation is requested by the server through the device cloud connection unit; and
a software bus function unit that performs connection with another component device when the virtual machine operation is requested by the server through the device cloud connection unit.

8. The component device according to claim 7, wherein the software bus function unit performs software bus connection initialization communication with a software bus function unit of the other component device when a virtual machine composition control signal is received from the server through the device cloud connection unit, and transmits a completion signal to the server through the device cloud connection unit.

9. The component device according to claim 7, wherein the software bus function unit requests a device function from the device function server when a virtual machine operation control signal is received from the server through the device cloud connection unit, and performs software bus connection communication with the other component device when a result of the device function is returned from the device function server.

10. A method of providing a virtual machine to at least one terminal in a server device providing cloud services, the method comprising:
receiving a virtual machine request from the terminal;
composing the virtual machine in accordance with the virtual machine request from the terminal; and
controlling the composed virtual machine to operate.

11. The method according to claim 10, further comprising:
classifying at least one component device to register resources when resource registration is requested from the at least one component device.

12. The method according to claim 10, wherein the receiving of the virtual machine request comprises:
generating a resource list including the component devices usable as the virtual machine to thereby transmit the generated resource list to the corresponding terminal when a virtual machine request signal is input from the terminal; and
receiving a selection resource list from the terminal.

13. The method according to claim 10, wherein the composing of the virtual machine comprises:
transmitting a virtual machine composition control signal to each of the component devices included in the selection resource list;
registering the corresponding component devices as the virtual machine when a connection initialization completion notification signal is received from the component devices; and
notifying the terminal of the registered virtual machine composition.

14. The method according to claim 10, wherein the controlling transmits a virtual machine operation control signal to the component devices when a virtual machine operation is requested by the terminal.

15. A method of providing a virtual machine in a component device providing cloud services, the method comprising:
performing software bus connection initialization by communicating with other component devices when a virtual machine composition control request is received from a server device;
transmitting a connection initialization completion notification signal to the server device when a software bus connection communication is completed; and
activating a device function when a virtual machine operation control signal is received from the server device and performing a software bus connection communication with the other component devices.

16. A system of providing a virtual machine using a device cloud, the system comprising:
a terminal that includes a user interface for a virtual machine request in a server providing cloud services;
at least one component device that is registered in the server to be usable as a virtual machine; and
a server that registers the at least one component device as a resource usable as the virtual machine and controls the at least one component device to operate as the virtual machine usable by the terminal in response to a request from the terminal.

17. The system according to claim 16, further comprising:
a legacy device; and
a proxy bridge that connects the legacy device to the server so that the legacy device operates as the component device.

18. The system according to claim 16, wherein the proxy bridge comprises:
a device cloud connection unit that performs connection with the server so that the component device is included in the cloud services;
a device function bridge unit that enables the legacy device to be recognized by the device cloud; and
a software bus function unit that performs connection with other component devices so that each legacy device composes the virtual machine.
